(19) United States
(12) Patent Application Publication
(10) Pub. No.: US 2003/0132825 A1
(43) Pub. Date: Jul. 17, 2003

(54) Planar coil and planar transformer

(76) Inventor: Masahiro Gamou, Tokyo (JP)

Correspondence Address: Oliff & Berridge, PO Box 19928, Alexandria, VA, 22320, US

(21) Appl. No.: 10/297,802

(22) PCT Filed: Feb. 28, 2002
(86) PCT No.: PCT/JP02/01843

(30) Foreign Application Priority Data
Mar. 8, 2001 (JP) 2001-65520

(51) Int. Cl. H01F 27/28

(52) U.S. Cl. 336/223

(57) ABSTRACT

An object of the invention is to reduce loss of a main winding by increasing the occupancy ratio of the area for accommodating the main winding conductor to the area for the entire conductors, and to attain a higher degree of flexibility in the number of turns of an auxiliary winding.

The main winding has a patterned conductor (11a) formed by arranging a plate-like conductor into a flat-spiral shape. The patterned conductor (11a) is adjacent to another patterned conductor for the main winding via an insulating layer (10), and is connected thereto via a through-hole (29). The auxiliary winding has a patterned conductor (11b) for the auxiliary winding that is located on the same plane as the patterned conductor (11a). The patterned conductor (11b) includes a portion that is wound one or more turns on an inner side relative to the through-hole (29).

### TECHNICAL FIELD

The present invention relates to a planar coil and a planar transformer having a winding that is responsible for main functions of the coil and the transformer, such as a smoothing function of the coil and main power transmission for the case of the transformer, and also a winding for performing other functions.

### BACKGROUND ART

Planar coils and planar transformers are used as choke coils and transformers in switching power supplies and the like. The planar coils and planar transformers have a winding made of a patterned conductor that is formed by arranging a plate-like conductor into a flat-spiral shape. In the planar transformers, or the planar coils having a plurality of patterned conductors, the plurality of patterned conductors are stacked in a direction of thickness, with an insulating layer interposed between adjacent ones of the conductors.

Among the planar coils and planar transformers, those which deliver relatively small output currents are formed by, for example, stacking a flat-spiral-shaped patterned conductor, an insulating layer, and a magnetic layer by a thin-film forming technique such as sputtering. On the other hand, for those which deliver medium output currents, print coils are employed which are formed by stacking double-sided printed circuit boards with an insulating layer interposed therebetween, the double-sided printed circuit boards each having flat-spiral-shaped patterned conductors on both sides thereof, which are formed by etching conductor layers on both sides of each printed circuit board. Those printed coils have a hole penetrating therethrough in a direction of thickness at a center portion of the patterned conductors. A magnetic substance such as an EE-type ferrite core is inserted in the hole.

Since such planar coils and planar transformers as mentioned above can be made thin, they are used for a compact and thin switching power supply and so on, in particular.

In recent years, because of decreased operating voltages and increased currents in ICs (Integrated Circuits) resulting from an increase in their scale of integration, it has been desired that a switching power supply be reduced in size and provide a large current. A loss caused by the resistance of a conductor in choke coils or transformers, i.e., the copper loss, increases in proportion to the square of the value of current. For this reason, it is significant to reduce the resistance value of conductors in the planar coils or planar transformers which are used as choke coils or transformers.

A planar coil or planar transformer is provided with a winding (hereinafter referred to as the main winding) that is responsible for main functions of the coil or the transformer, such as a smoothing function of the coil or main power transmission for the case of the transformer. In addition to the main winding, the planar coil or planar transformer may be provided with an auxiliary winding for performing other functions. For example, the auxiliary winding can be used for generating power to be supplied to ICs that constitute the control circuit or the like of a switching power supply, or for detecting a voltage across the main winding.

Conventionally, a planar transformer having an auxiliary winding is often provided with a conductor layer that constitutes the auxiliary winding, separately from a conductor layer that constitutes the main winding. In this case, to provide the auxiliary winding, two conductor layers are necessary which are wound in opposite directions and are connected to each other at their inner ends via a through-hole or the like, except for the case where the auxiliary winding consists of one turn.

Unlike the main winding responsible for smoothing the output current of a switching power supply, or for transmitting main power, the auxiliary winding in the planar coil or planar transformer is mainly responsible for supplying power to a control circuit of the switching power supply. For this reason, the current flowing through the auxiliary winding is much smaller than the current flowing through the main winding. Since a large current flowing through the auxiliary winding would reduce the conversion efficiency of the entire switching power supply, efforts have been made to minimize the current flowing through the auxiliary winding.

As described above, to provide conductor layers to constitute the auxiliary winding separately from conductor layers constituting the main winding, two conductor layers will be required for the auxiliary winding. Thus, in this case, there arises a problem that the existence of the auxiliary winding would reduce the occupancy ratio of the area for accommodating the conductor of the main winding to the area for the entire conductors, thereby causing an increased copper loss of the main winding.

To cope with this, Published Unexamined Japanese Patent Application (KOKAI) Heisei 10-163039 discloses a transformer in which the auxiliary winding is formed on the same layer plane as the main winding. This publication discloses an example in which the main winding consists of four turns while the auxiliary winding consists of two turns, and examples in which the main winding consists of three turns while the auxiliary winding consists of one turn, two turns, three turns, and five turns.

However, in any of the examples disclosed in the aforementioned publication, the auxiliary winding is disposed along the main winding inside or outside the main winding, and is wound in the same manner as the main winding. Thus, in this case, the number of turns of the auxiliary winding naturally depends on the number of turns of the main winding, and therefore it is difficult to provide an auxiliary winding of which the number of turns is significantly different from that of the main winding.

### DISCLOSURE OF THE INVENTION

It is a first object of the invention to provide a planar coil having a first winding and a second winding, the planar coil allowing a reduction in a loss of the first winding by providing a high occupancy ratio of the area for accommodating the conductor of the first winding to the area for the entire conductors, and allowing a high degree of flexibility in the number of turns of the second winding.

It is a second object of the invention to provide a planar coil having a main winding and an auxiliary winding, the planar coil allowing a reduction in a loss of the main winding by providing a high occupancy ratio of the area for accommodating the conductor of the main winding to the area for the entire conductors, and allowing a high degree of flexibility in the number of turns of the auxiliary winding.

It is a third object of the invention to provide a planar transformer having an auxiliary winding in addition to a primary winding and a secondary winding, the planar transformer allowing reductions in losses of the primary and secondary windings by providing a high occupancy ratio of the area for accommodating the conductors of the primary and secondary windings to the area for the entire conductors, and allowing a high degree of flexibility in the number of turns of the auxiliary winding.

A first planar coil according to the invention comprises a first winding and a second winding each formed of a conductor, wherein: the first winding has a first patterned conductor and a second patterned conductor each formed by arranging a conductor into a flat-spiral shape, the first and second patterned conductors being adjacent to each other via an insulating layer and having inner ends connected to each other; and the second winding has a third patterned conductor including a portion that is wound one or more turns on an inner side relative to a connecting part that connects the inner ends of the first and second patterned conductors to each other, the third patterned conductor being located on the same plane as at least one of the first and second patterned conductors.

In the first planar coil according to the invention, the third patterned conductor of the second winding is located on the same plane as at least one of the first and second patterned conductors of the first winding. This allows a high occupancy ratio of the area for accommodating the conductor of the first winding to the area for the entire conductors. Furthermore, according to the invention, the third patterned conductor includes a portion that is wound one or more turns on the inner side relative to the connecting part that connects the inner ends of the first and second patterned conductors to each other. It is therefore possible to attain a higher degree of flexibility in the number of turns of the second winding. It should be noted that the present invention covers not only the case where the first and second patterned conductors are adjacent to each other via an insulating layer alone, but also the case where the first and second patterned conductors are adjacent to each other via an insulating layer and another layer.

A second planar coil according to the invention comprises a main winding for performing a predetermined function and an auxiliary winding for performing another function, each of the windings being formed of a conductor, wherein: the main winding has a first patterned conductor and a second patterned conductor each formed by arranging a conductor into a flat-spiral shape, the first and second patterned conductors being adjacent to each other via an insulating layer and having inner ends connected to each other; and the auxiliary winding has a patterned conductor for the auxiliary winding, the patterned conductor for the auxiliary winding including a portion that is wound one or more turns on an inner side relative to a connecting part that connects the inner ends of the first and second patterned conductors to each other, the patterned conductor for the auxiliary winding being located on the same plane as at least one of the first and second patterned conductors.

In the second planar coil according to the invention, the patterned conductor for the auxiliary winding is located on the same plane as at least one of the first and second patterned conductors. This allows a high occupancy ratio of the area for accommodating the conductor of the main winding to the area for the entire conductors. Furthermore, according to the invention, the patterned conductor for the auxiliary winding includes a portion that is wound one or more turns on the inner side relative to the connecting part that connects the inner ends of the first and second patterned conductors to each other. It is therefore possible to attain a higher degree of flexibility in the number of turns of the auxiliary winding. It should be noted that the present invention covers not only the case where the first and second patterned conductors are adjacent to each other via an insulating layer alone, but also the case where the first and second patterned conductors are adjacent to each other via an insulating layer and another layer.

A planar transformer according to the invention comprises a primary winding and a secondary winding each formed of a conductor arranged into a flat shape, and an auxiliary winding provided separately from the primary winding and the secondary winding, wherein: at least one of the primary and secondary windings has a first patterned conductor and a second patterned conductor each formed by arranging a conductor into a flat-spiral shape, the first and second patterned conductors being adjacent to each other via an insulating layer and having inner ends connected to each other; and the auxiliary winding has a patterned conductor for the auxiliary winding that is formed by arranging a conductor into a flat-spiral shape, the patterned conductor for the auxiliary winding including a portion that is wound one or more turns on an inner side relative to a connecting part that connects the inner ends of the first and second patterned conductors to each other, the patterned conductor for the auxiliary winding being located on the same plane as at least one of the first and second patterned conductors.

In the planar transformer according to the invention, the patterned conductor for the auxiliary winding is located on the same plane as at least one of the first and second patterned conductors. This allows a high occupancy ratio of the area for accommodating the conductors of the primary and secondary windings to the area for the entire conductors. Furthermore, according to the invention, the patterned conductor for the auxiliary winding includes a portion that is wound one or more turns on the inner side relative to the connecting part that connects the inner ends of the first and second patterned conductors to each other. It is therefore possible to attain a higher degree of flexibility in the number of turns of the auxiliary winding. It should be noted that the present invention covers not only the case where the first and second patterned conductors are adjacent to each other via an insulating layer alone, but also the case where the first and second patterned conductors are adjacent to each other via an insulating layer and another layer.

In the planar transformer according to the invention, one of the primary and secondary windings may have the first patterned conductor and the second patterned conductor; and the other of the primary and secondary windings may have a patterned conductor including a portion that is wound one or more turns on an inner side relative to a connecting part that connects the inner ends of the first and second patterned conductors to each other, the patterned conductor being located on a different plane from the first and second patterned conductors.

In the planar transformer according to the invention, the inner ends of the first and second patterned conductors may be connected to each other via a connecting hole that entirely penetrates the planar transformer in a direction of its thickness.

In the planar transformer according to the invention, conductor layers including the patterned conductors to constitute the primary winding and conductor layers including the patterned conductors to constitute the secondary winding may be alternately stacked via an insulating layer.

Other objects, features and advantages of the invention will become sufficiently clear from the following description.

### BRIEF DESCRIPTION OF THE DRAWINGS

FIG. 1 is a top view of a planar coil according to a first embodiment of the invention.

FIG. 2 is a right-hand side view of the planar coil shown in FIG. 1.

FIG. 3 is an enlarged cross-sectional view taken along line 3-3 of FIG. 1.

FIG. 4 is a top view showing a core of the planar coil according to the first embodiment of the invention.

FIG. 5 is a side view of the core of the planar coil according to the first embodiment of the invention.

FIG. 6 is a top view showing the uppermost conductor layer and an insulating layer below the same of the planar coil according to the first embodiment of the invention.

FIG. 7 is a top view showing the second uppermost conductor layer and an insulating layer below the same of the planar coil according to the first embodiment of the invention.

FIG. 8 is a top view showing the third uppermost conductor layer and an insulating layer below the same of the planar coil according to the first embodiment of the invention.

FIG. 9 is a top view showing the lowermost conductor layer of the planar coil according to the first embodiment of the invention.

FIG. 10 is a top view showing the insulating layer of the planar coil according to the first embodiment of the invention.

FIG. 11 is a top view showing the uppermost conductor layer and an insulating layer below the same of a planar coil of a comparative example.

FIG. 12 is a top view showing the second uppermost conductor layer and an insulating layer below the same of the planar coil of the comparative example.

FIG. 13 is a top view showing the third uppermost conductor layer and an insulating layer below the same of the planar coil of the comparative example.

FIG. 14 is a top view showing the lowermost conductor layer of the planar coil of the comparative example.

FIG. 15 is a top view of a planar transformer according to a second embodiment of the invention.

FIG. 16 is a right-hand side view of the planar transformer shown in FIG. 15.

FIG. 17 is an enlarged cross-sectional view taken along line 17-17 of FIG. 15.

FIG. 18 is a top view showing the uppermost conductor layer and an insulating layer below the same of the planar transformer according to the second embodiment of the invention.

FIG. 19 is a top view showing the second uppermost conductor layer and an insulating layer below the same of the planar transformer according to the second embodiment of the invention.

FIG. 20 is a top view showing the third uppermost conductor layer and an insulating layer below the same of the planar transformer according to the second embodiment of the invention.

FIG. 21 is a top view showing the lowermost conductor layer of the planar transformer according to the second embodiment of the invention.

FIG. 22 is a top view showing the insulating layer of the planar transformer according to the second embodiment of the invention.

### BEST MODE FOR CARRYING OUT THE INVENTION

Embodiments of the invention will now be described in detail with reference to the drawings.

[First Embodiment]

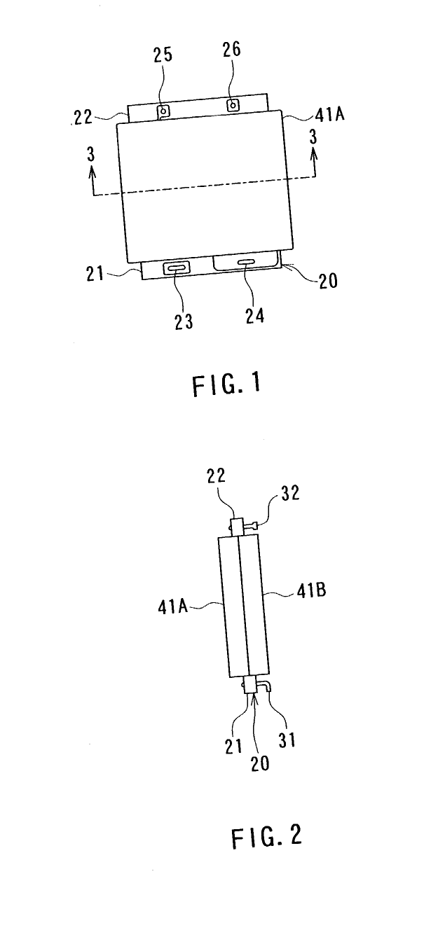

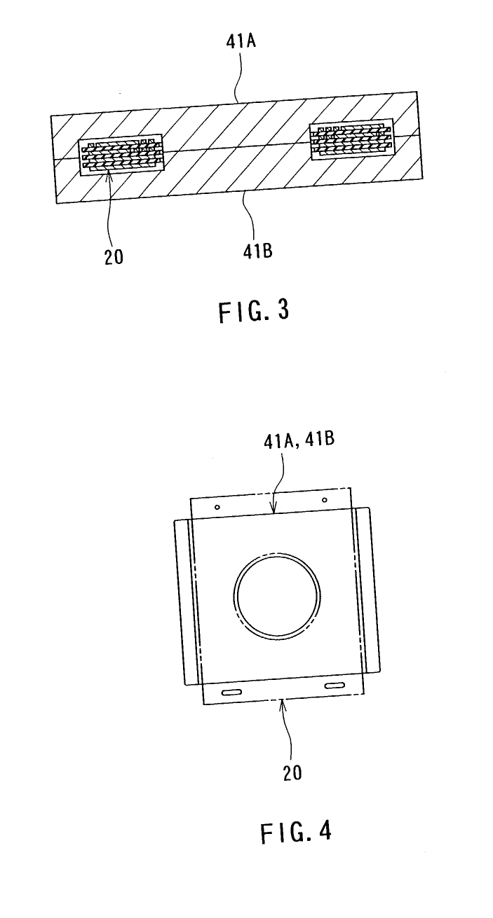

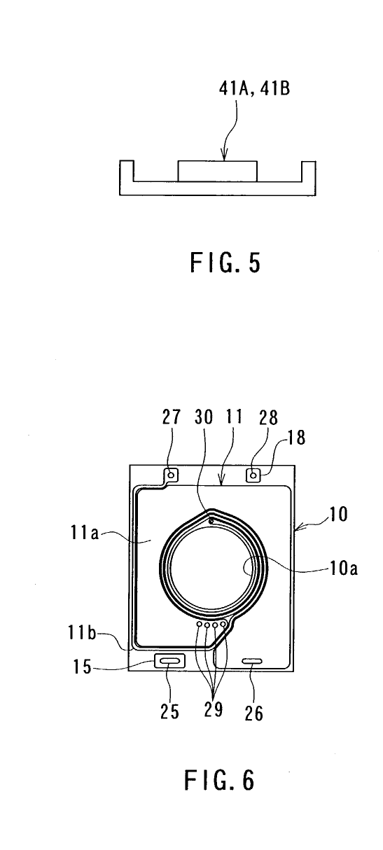

First, with reference to FIG. 1 through FIG. 5, description will be given of an overall configuration of a planar coil according to a first embodiment of the invention. FIG. 1 is a top view of the planar coil according to the present embodiment. FIG. 2 is a right-hand side view of the planar coil shown in FIG. 1. FIG. 3 is an enlarged cross-sectional view taken along line 3-3 of FIG. 1. FIG. 4 is a top view showing a core of the planar coil according to the present embodiment. FIG. 5 is a side view of the core.

The planar coil according to the present embodiment has a main winding for performing a predetermined function and an auxiliary winding for performing another function, each of the windings being formed of a plate-shaped conductor including a foil-shaped conductor. The main winding is responsible for a main function of the coil such as a smoothing function. The auxiliary winding has a function of supplying power to a control circuit of a switching power supply, for example. In the present embodiment, the main winding consists of two turns while the auxiliary winding consists of six turns. For example, the planar coil according to the embodiment is used as a choke coil. The main winding in the present embodiment corresponds to the first winding of the invention, while the auxiliary winding corresponds to the second winding of the invention.

As shown in FIG. 1 through FIG. 3, the planar coil according to the embodiment comprises a stacked body 20 made up of four conductor layers and three insulating layers that are alternately stacked as described later, and an E-type cores 41A and 41B mounted on the stacked body 20.

As shown in. FIG. 1 and FIG. 2, the stacked body 20 has terminal areas 21 and 22. The terminal areas 21 and 22 are located opposite to each other outside the cores 41A and 41B. Through-holes 23 and 24 are provided in the terminal area 21, while through-holes 25 and 26 are provided in the terminal area 22. As shown in FIG. 2, for example, each of the through-holes 23 and 24 allows a terminal 31 to be inserted in, while each of the through-holes 25 and 26 allows a terminal 32 to be inserted in.

Additionally, as shown in FIG. 3, the E-type cores 41A and 41B are disposed to allow their central projections to butt against each other through a hole 10a of an insulating layer 10 to be described later.

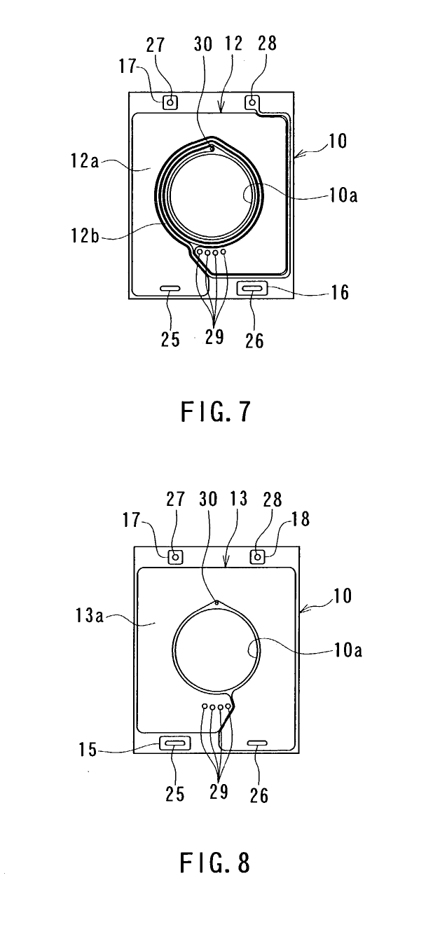

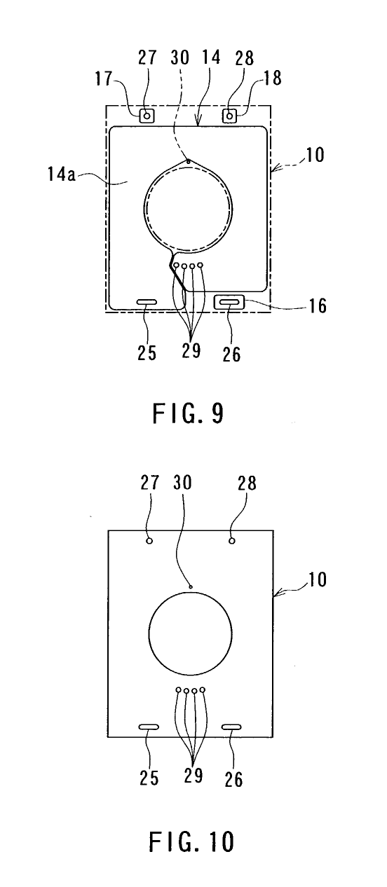

Next, with reference to FIG. 6 through FIG. 10, description will be given of the conductor layers and insulating layers making up the stacked body 20. FIG. 6 is a top view showing the uppermost conductor layer 11 and an insulating layer 10 below the same. FIG. 7 is a top view showing the second uppermost conductor layer 12 and an insulating layer 10 below the same. FIG. 8 is a top view showing the third uppermost conductor layer 13 and an insulating layer 10 below the same. FIG. 9 is a top view showing the lowermost conductor layer 14. FIG. 10 is a top view showing an insulating layer 10.

As shown in FIG. 10, each insulating layer 10 is rectangular plate-shaped. There is formed a circular hole 10a at the central part of each insulating layer 10 excluding the terminal areas 21 and 22. In each of the conductor layers 11 to 14, a patterned conductor is disposed in an area between the perimeter of the hole 10a and the perimeter of the insulating layer 10.

As shown in FIG. 6 through FIG. 9, the conductor layers 11 to 14 respectively have patterned conductors 11a to 14a for the main winding. Each of the patterned conductors 11a to 14a is formed by arranging a plate-like or foil-like conductor into a flat-spiral shape, and forms one turn. The conductor may be copper, for example.

The patterned conductor 11a and the patterned conductor 13a are wound in a counterclockwise direction from outer to inner side. On the other hand, the patterned conductor 12a and the patterned conductor 14a are wound in a clockwise direction from outer to inner side. Thus, the patterned conductors 11a/13a and the patterned conductors 12a/14a are wound in opposite directions.

The patterned conductors 11a to 14a are overlaid on top of another, with an insulating layer 10 interposed between adjacent ones. The inner ends of the patterned conductors 11a to 14a are electrically connected to each other via through-holes 29 that penetrate the stacked body 20 in a direction of its thickness. The patterned conductors 11a to 14a thereby constitute the main winding consisting of two turns. The patterned conductor 11a corresponds to the first patterned conductor of the invention, while the patterned conductor 12a corresponds to the second patterned conductor of the invention. The through-holes 29 correspond to the connecting part of the invention.

As shown in FIG. 6, the outer end of the patterned conductor 11a is connected to the through-hole 26. The conductor layer 11 further has a patterned conductor 11b for the auxiliary winding. The patterned conductor 11b is formed by arranging a plate-like or foil-like conductor into a flat-spiral shape, and forms three turns. The patterned conductor 11b is wound in a counterclockwise direction from outer to inner side. The outer end of the patterned conductor 11b is connected to a through-hole 27. As the patterned conductor 11b is viewed so as to follow its path from the outer end to the inner end, a portion corresponding to a first 0.5 turn goes along the outside of the patterned conductor 11a. Then, the patterned conductor 11b passes through between the outer and inner ends of the patterned conductor 11a to enter an inner side relative to the positions of the through-holes 29, and is wound 2.5 turns in between the inner circumference of the patterned conductor 11a and the perimeter of the hole 10a. The conductor layer 11 further has terminal layers 15 and 18 that are connected to the through-holes 25 and 28, respectively.

As shown in FIG. 7, the outer end of the patterned conductor 12a is connected to the through-hole 25. The conductor layer 12 further has a patterned conductor 12b for the auxiliary winding. The patterned conductor 12b is formed by arranging a plate-like or foil-like conductor into a flat-spiral shape, and forms three turns. The patterned conductor 12b is wound in a clockwise direction from outer to inner side. The outer end of the patterned conductor 12b is connected to a through-hole 28. As the patterned conductor 12b is viewed so as to follow its path from the outer end along the way to the inner end, a portion corresponding to a first 0.5 turn goes along the outside of the patterned conductor 12a. Then, the patterned conductor 12b passes through between the outer and inner ends of the patterned conductor 12a to enter an inner side relative to the positions of the through-holes 29, and is wound 2.5 turns in between the inner circumference of the patterned conductor 12a and the perimeter of the hole 10a. The conductor layer 12 further has terminal layers 16 and 17 that are connected to the through-holes 26 and 27, respectively.

The inner ends of the patterned conductors 11b and 12b are electrically connected to each other via a through-hole 30 that penetrates the stacked body 20 in a direction of its thickness. The patterned conductors 11b and 12b thereby constitute the auxiliary winding consisting of six turns.

As shown in FIG. 8, the outer end of the patterned conductor 13a is connected to the through-hole 26. The patterned conductor 13a is disposed to avoid the through-hole 30. The conductor layer 13 further has terminal layers 15, 17, and 18 that are connected to the through-holes 25, 27, and 28, respectively.

As shown in FIG. 9, the outer end of the patterned conductor 14a is connected to the through-hole 25. The patterned conductor 14a is disposed to avoid the through-hole 30. The conductor layer 14 further has terminal layers 16, 17, and 18 that are connected to the through-holes 26, 27, and 28, respectively.

The conductor layer 11 and the conductor layer 12 may be formed by etching conductor layers formed on both sides of an insulating substrate of a double-sided printed circuit board. The conductor layers 13 and 14 may be formed in the same manner. In this case, the stacked body 20 may be fabricated by stacking two double-sided printed circuit boards via the insulating layer 10. Alternatively, the stacked body of the insulating layer 10 may be fabricated by: etching conductor layers on a double-sided printed circuit board to thereby form the conductor layers 12 and 13, then stacking single-sided printed circuit boards on top and bottom of the double-sided printed circuit board via an insulating layer each, and then etching conductor layers of the two exposed single-sided printed circuit boards to thereby form the conductor layers 11 and 14. Alternatively, the stacked body 20 may be fabricated by using a thin-film forming technique such as a sputtering method.

Now, for comparison with the planar coil according to the present embodiment, described below is a comparative example in which a conductor layer forming the main winding is separate from a conductor layer forming the auxiliary winding. In this comparative example, as in the present embodiment, there are provided four conductor layers and three insulating layers, and the main winding consists of two turns while the auxiliary winding consists of six turns.

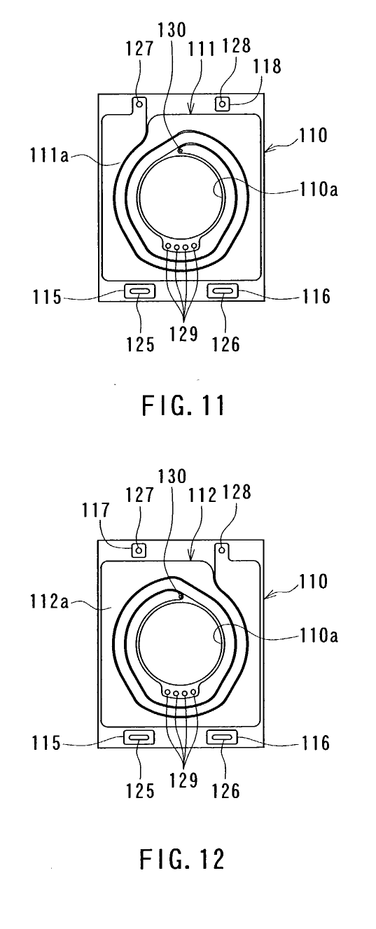

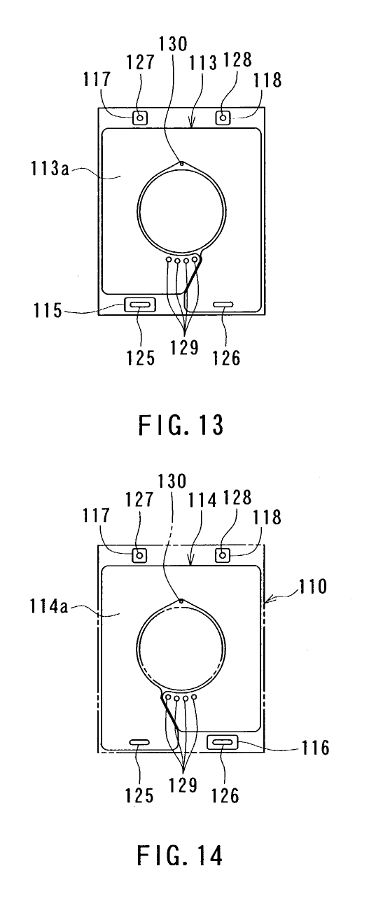

FIG. 11 is a top view showing the uppermost conductor layer 111 and an insulating layer 110 below the same of the comparative example. FIG. 12 is a top view showing the second uppermost conductor layer 112 and an insulating layer 110 below the same of the comparative example. FIG. 13 is a top view showing the third uppermost conductor layer 113 and an insulating layer 110 below the same of the comparative example. FIG. 14 is a top view showing the lowermost conductor layer 114 of the comparative example.

The insulating layers 110 are the same in shape as the insulating layers 10 of the present embodiment. The stacked body made up of the conductor layers 111 to 114 and the insulating layers 110 has through-holes 125 to 128 at positions corresponding to the through-holes 25 to 28 of the present embodiment.

The conductor layers 111 and 112 respectively have patterned conductors 111a and 112a for the auxiliary winding, each of the patterned conductors 111a and 112a forming three turns. The patterned conductors 111a and 112a are wound in opposite directions. The outer end of the patterned conductor 111a is connected to the through-hole 127. The outer end of the patterned conductor 112a is connected to the through-hole 128. The inner ends of the patterned conductors 111a and 112a are electrically connected to each other via a through-hole 130 that penetrates the stacked body in a direction of its thickness. The patterned conductors 111a and 112a thereby constitute the auxiliary winding consisting of six turns. The conductor layer 111 further has terminal layers 115, 116, and 118 that are connected to the through-holes 125, 126, and 128, respectively. The conductor layer 112 further has terminal layers 115, 116, and 117 that are connected to the through-holes 125, 126, and 127, respectively.

The conductor layers 113 and 114 respectively have patterned conductors 113a and 114a for the main winding, each of the patterned conductors 113a and 114a forming one turn. The patterned conductors 113a and 114a are wound in opposite directions. The outer end of the patterned conductor 113a is connected to the through-hole 126. The outer end of the patterned conductor 114a is connected to the through-hole 125. The inner ends of the patterned conductors 113a and 114a are electrically connected to each other via a through-hole 129 that penetrates the stacked body in a direction of its thickness. The patterned conductors 113a and 114a thereby constitute the main winding consisting of two turns. The conductor layer 113 further has terminal layers 115, 117, and 118 that are connected to the through-holes 125, 127, and 128, respectively. The conductor layer 114 further has terminal layers 116, 117, and 118 that are connected to the through-holes 126, 127, and 128, respectively.

In the planar coil of the comparative example, the patterned conductors 111a and 112a for the auxiliary winding are provided in different layers from those of the patterned conductors 113a and 114a for the main winding, and the main winding is constituted by the two conductor layers 113 and 114.

In contrast to this, in the planar coil according to the present embodiment, the patterned conductors 11b and 12b for the auxiliary winding are provided on the same plane as the patterned conductors 11a and 12a for the main winding, and the main winding is constituted by the four conductor layers 11 to 14. Thus, as compared with the comparative example, the present embodiment provides a much greater occupancy ratio of the area for accommodating the main winding conductor to the area for the entire conductors. Accordingly, the present embodiment makes it possible to reduce the resistance of the main winding conductor significantly, and to thereby reduce loss of the main winding significantly.

Furthermore, according to the present embodiment, the patterned conductors 11b and 12b for the auxiliary winding each include a portion that is wound one or more turns on an inner side relative to the connecting part (through-holes 29) that connects the inner ends of the patterned conductors 11a to 14a for the main winding to each other. This makes it possible to attain a higher degree of flexibility in the number of turns of the auxiliary winding. For example, although the present embodiment is configured so that the portions of the patterned conductors 11b and 12b for the auxiliary winding located on the inner side relative to the connecting part (through-holes 29) are wound 2.5 turns each, the number of turns of the portions can be easily changed. As a result, the number of turns of the auxiliary winding can also be changed easily.

[Second Embodiment]

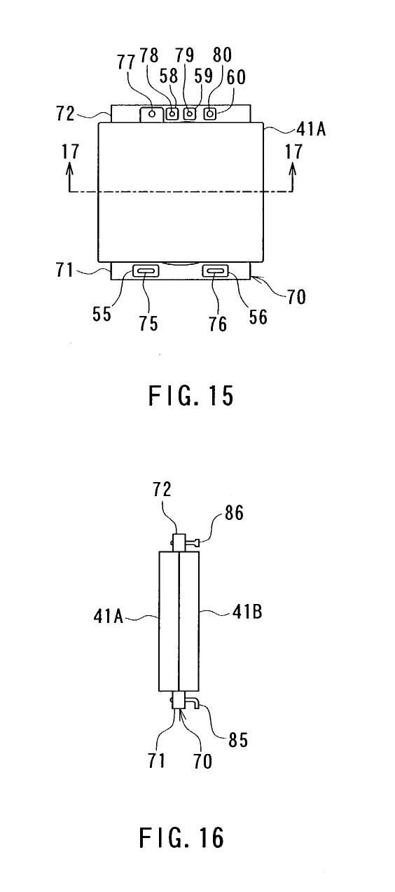

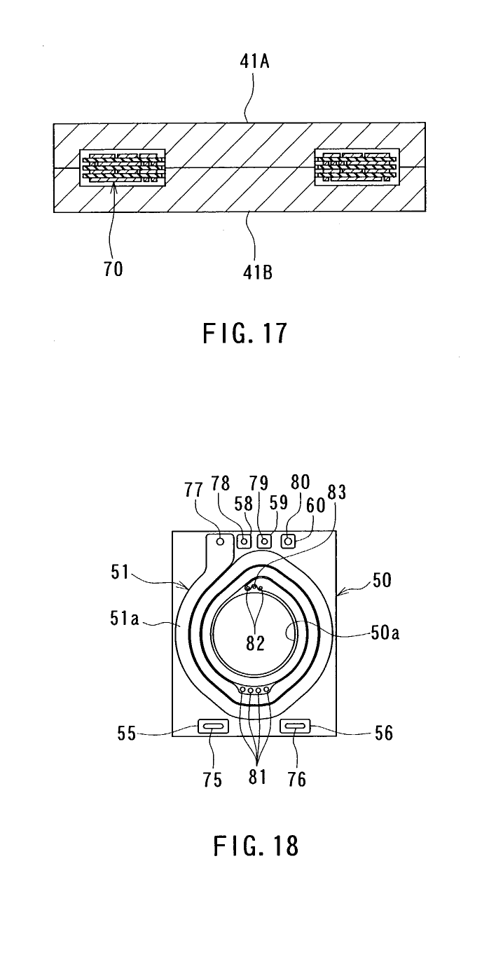

Next, description will be given of a planar transformer according to a second embodiment of the invention. First, an overall configuration of the planar transformer according to the embodiment will be described with reference to FIG. 15 through FIG. 17. FIG. 15 is a top view of the planar transformer according to the embodiment. FIG. 16 is a right-hand side view of the planar transformer shown in FIG. 1. FIG. 17 is an enlarged cross-sectional view taken along line 17-17 of FIG. 15.

The planar transformer according to the embodiment has a primary winding and a secondary winding each formed of a conductor arranged into a flat shape, and an auxiliary winding provided separately from the primary winding and the secondary winding. The primary winding and the secondary winding are responsible for main functions of the transformer such as main power transmission. The auxiliary winding has a function of, e.g., supplying power to a control circuit of a switching power supply. In the embodiment, the primary winding consists of six turns, the secondary winding consists of two turns, and the auxiliary winding consists of five turns.

As shown in FIG. 15 through FIG. 17, the planar transformer according to the embodiment comprises a stacked body 70 made up of four conductor layers and three insulating layers that are alternately stacked as described later, and the E-type cores 41A and 41B mounted on the stacked body 70.

As shown in FIG. 15 and FIG. 16, the stacked body 70 has terminal areas 71 and 72. The terminal areas 71 and 72 are located opposite to each other outside the cores 41A and 41B. Through-holes 75 and 76 are provided in the terminal area 71, while through-holes 77 to 80 are provided in the terminal area 72. As shown in FIG. 16, for example, each of the through-holes 75 and 76 allows a terminal 85 to be inserted in, while each of the through-holes 77 to 80 allows a terminal 86 to be inserted in.

Additionally, as shown in FIG. 17, the E-type cores 41A and 41B are disposed to allow their central projections to butt against each other through a hole 50a of an insulating layer 50 to be described later.

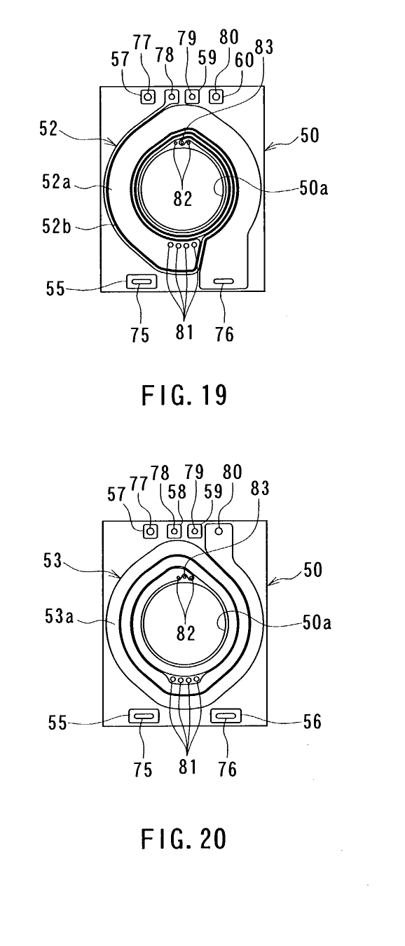

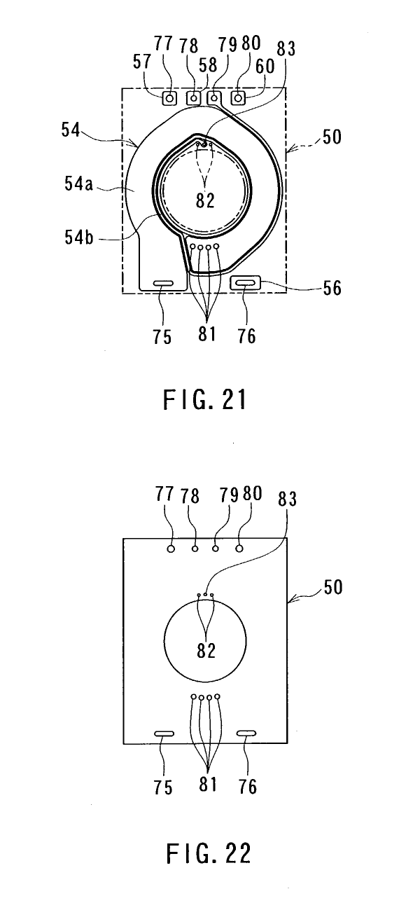

Next, with reference to FIG. 18 through FIG. 22, description will be given of the conductor layers and insulating layers making up the stacked body 70. FIG. 18 is a top view showing the uppermost conductor layer 51 and an insulating layer 50 below the same. FIG. 19 is a top view showing the second uppermost conductor layer 52 and an insulating layer 50 below the same. FIG. 20 is a top view showing the third uppermost conductor layer 53 and an insulating layer 50 below the same. FIG. 21 is a top view showing the lowermost conductor layer 54. FIG. 22 is a top view showing an insulating layer 50.

As shown in FIG. 22, each insulating layer 50 is rectangular plate-shaped. There is formed a circular hole 50a at the central part of each insulating layer 50 excluding the terminal areas 71 and 72. A patterned conductor in each of the conductor layers 51 to 54 is disposed in an area between the perimeter of the hole 50a and the perimeter of the insulating layer 50.

As shown in FIG. 18 and FIG. 20, the conductor layers 51 and 53 respectively have patterned conductors 51a and 53a for the primary winding. Each of the patterned conductors 51a and 53a is formed by arranging a plate-like or foil-like conductor into a flat-spiral shape, and forms three turns. The conductor may be copper, for example.

The patterned conductor 51a is wound in a counterclockwise direction from outer to inner side. On the other hand, the patterned conductor 53a is wound in a clockwise direction from outer to inner side. Thus, the patterned conductor 51a and the patterned conductor 53a are wound in opposite directions.

The patterned conductors 51a and 53a are adjacent to each other via two insulating layers 50 and the conductor layer 52 sandwiched between the two insulating layers. The inner ends of the patterned conductors 51a and 53a are electrically connected to each other via through-holes 82 that entirely penetrate the stacked body 70, i.e., the planar transformer excluding the cores 41A and 42B, in a direction of its thickness. The patterned conductors 51a and 53a thereby constitute the primary winding consisting of six turns.

As shown in FIG. 18, the outer end of the patterned conductor 51a is connected to the through-hole 77. The conductor layer 51 further has terminal layers 55, 56, 58, 59, and 60 connected to the through-holes 75, 76, 78, 79, and 80, respectively.

As shown in FIG. 20, the outer end of the patterned conductor 53a is connected to the through-hole 80. The conductor layer 53 further has terminal layers 55, 56, 57, 58, and 59 connected to the through-holes 75, 76, 77, 78, and 79, respectively.

As shown in FIG. 19 and FIG. 21, the conductor layers 52 and 54 respectively have patterned conductors 52a and 54a for the secondary winding. Each of the patterned conductors 52a and 54a is formed by arranging a plate-like or foil-like conductor into a flat-spiral shape, and forms one turn.

The patterned conductor 52a is wound in a counterclockwise direction from outer to inner side. On the other hand, the patterned conductor 54a is wound in a clockwise direction from outer to inner side. Thus, the patterned conductor 52a and the patterned conductor 54a are wound in opposite directions.

The patterned conductors 52a and 54a are adjacent to each other via two insulating layers 50 and the conductor layer 53 sandwiched between the two insulating layers. The inner ends of the patterned conductors 52a and 54a are electrically connected to each other via through-holes 81 that entirely penetrate the stacked body 70, i.e., the planar transformer excluding the cores 41A and 42B, in a direction of its thickness. The patterned conductors 52a and 54a thereby constitute the secondary winding consisting of two turns. The through-holes 81 correspond to the connecting part or the connecting hole of the invention.

As shown in FIG. 19, the outer end of the patterned conductor 52a is connected to the through-hole 76. The conductor layer 52 further has a patterned conductor 52b for the auxiliary winding. The patterned conductor 52b is formed by arranging a plate-like or foil-like conductor into a flat-spiral shape, and forms three turns. The patterned conductor 52b is wound in a counterclockwise direction from outer to inner side. The outer end of the patterned conductor 52b is connected to the through-hole 78. As the patterned conductor 52b is viewed so as to follow its path from the outer end to the inner end, a portion corresponding to a first 0.5 turn goes along the outside of the patterned conductor 52a. Then, the patterned conductor 52b passes through between the outer and inner ends of the patterned conductor 52a to enter an inner side relative to the positions of the through-holes 81, and is wound 2.5 turns in between the inner circumference of the patterned conductor 52a and the perimeter of the hole 50a. The conductor layer 52 further has terminal layers 55, 57, 59, and 60 that are connected to the through-holes 75, 77, 79, and 80, respectively.

As shown in FIG. 21, the outer end of the patterned conductor 54a is connected to the through-hole 75. The conductor layer 54 further has a patterned conductor 54b for the auxiliary winding. The patterned conductor 54b is formed by arranging a plate-like or foil-like conductor into a flat-spiral shape, and forms three turns. The patterned conductor 54b is wound in a clockwise direction from outer to inner side. The outer end of the patterned conductor 54b is connected to the through-hole 79. As the patterned conductor 54b is viewed so as to follow its path from the outer end to the inner end, a portion corresponding to a first 0.5 turn goes along the outside of the patterned conductor 54a. Then, the patterned conductor 54b passes through between the outer and inner ends of the patterned conductor 54a to enter an inner side relative to the positions of the through-holes 81, and is wound 1.5 turns in between the inner circumference of the patterned conductor 54a and the perimeter of the hole 50a. The conductor layer 54 further has terminal layers 56, 57, 58, and 60 that are connected to the through-holes 76, 77, 78, and 80, respectively.

The inner ends of the patterned conductors 52b and 54b are electrically connected to each other via a through-hole 83 that entirely penetrates the stacked body 70, i.e., the planar transformer excluding the cores 41A and 42B, in a direction of its thickness. The patterned conductors 52b and 54b thereby constitute the auxiliary winding consisting of five turns.

As shown in FIG. 18 and FIG. 20, the patterned conductors 51a and 53a for the primary winding are disposed to avoid the through-holes 81 and 83. The patterned conductors 51a and 53a for the primary winding each include a portion that is wound one turn on an inner side relative to the through-holes 81.

The conductor layer 51 and the conductor layer 52 may be formed by etching conductor layers formed on both sides of an insulating substrate of a double-sided printed circuit board. The conductor layers 53 and 54 may be formed in the same manner. In this case, the stacked body 70 may be fabricated by stacking two double-sided printed circuit boards via the insulating layer 50. Alternatively, the stacked body of the insulating layer 70 may be fabricated by: etching conductor layers on a double-sided printed circuit board to thereby form the conductor layers 52 and 53, then stacking single-sided printed circuit boards on top and bottom of the double-sided printed circuit board via an insulating layer, and then etching conductor layers of the two exposed single-sided printed circuit boards to thereby form the conductor layers 51 and 54. Alternatively, the stacked body 70 may be fabricated by using a thin-film forming technique such as a sputtering method.

As has been described, in the planar transformer according to the present embodiment, the patterned conductors 52b and 54b for the auxiliary winding are provided on the same plane as the patterned conductors 52a and 54a for the secondary winding, and any conductor layer solely for the auxiliary winding is not provided. Thus, the present embodiment provides a much greater occupancy ratio of the area for accommodating the primary and secondary winding conductors to the area for the entire conductors. Accordingly, the present embodiment makes it possible to reduce the resistances of the primary and secondary winding conductors significantly, and to thereby reduce loss of the primary and secondary windings significantly.

Furthermore, according to the present embodiment, the patterned conductors 52b and 54b for the auxiliary winding each include a portion that is wound one or more turns on an inner side relative to the connecting part (through-holes 81) that connects the inner ends of the patterned conductors 52a and 54a for the secondary winding to each other. This makes it possible to attain a higher degree of flexibility in the number of turns of the auxiliary winding. For example, although the present embodiment is configured so that the portions of the patterned conductors 52b and 54b for the auxiliary winding located on the inner side relative to the connecting part (through-holes 81) are wound 2.5 turns and 1.5 turns, respectively, the number of turns can be easily changed for each of the portions. As a result, the number of turns of the auxiliary winding can also be changed easily.

Furthermore, according to the embodiment, the patterned conductors 51a and 53a for the primary winding each include a portion that is wound one turn on the inner side relative to the through-holes 81 that connect the patterned conductors 52a and 54a for the secondary winding to each other. In the conductor layers 52 and 54, a portion of each of the patterned conductors 52b and 54b for the auxiliary winding is disposed on the inner side relative to the through-holes 81. Since there exists no patterned conductor for the auxiliary winding in the conductor layers 51 and 53, a portion of each of the patterned conductors 51a and 53a for the primary winding can be disposed on the inner side relative to the through-holes 81. This allows an effective use of the area for accommodating the entire conductors, and consequently makes it possible to implement a planar transformer with a reduced copper loss. Incidentally, the portions of the patterned conductors 51a and 53a for the primary winding disposed on the inner side relative to the through-holes 81 may each form more than one turn.

In the present embodiment, the conductor layers 51 and 53 including the patterned conductors 51a and 53a, respectively, to constitute the primary winding, and the conductor layers 52 and 54 including the patterned conductors 52a and 54a, respectively, to constitute the secondary winding, are alternately stacked via an insulating layer 50. This makes it possible to reduce the high-frequency resistance of the planar transformer and increase the coupling coefficient between the primary winding and the secondary winding. The high-frequency resistance of the planar transformer is larger than the direct-current resistance due to the effect of the magnetic field generated by the high-frequency current itself, i.e., the skin effect. However, when the conductor layers 51 and 53 for the primary winding and the conductor layers 52 and 54 for the secondary winding are alternately stacked as in the present embodiment, the magnetic field caused by a primary winding current in the patterned conductor 51a is cancelled by a secondary winding current in the patterned conductor 52a, for example. This makes the patterned conductor 53a less susceptible to the magnetic field, resulting in a reduction in high-frequency resistance.

For fabricating printed coils, in particular, often employed is a method in which a double-sided printed circuit board with copper foils formed on both sides is punched and subjected to plating for forming through-holes for continuity between the copper foils on both sides, and then the copper foils on both sides are etched to form a flat-spiral pattern, so that a plurality of such double-sided printed circuit boards are stacked via insulating layers. When this method is employed, a through-hole in one double-sided printed circuit board would not reach a conductor layer on another double-sided printed circuit board. Accordingly, when this method is employed to fabricate a planar transformer, for example, a through-hole connected to a conductor layer for the secondary winding exerts no effects on a patterned conductor for the primary winding which is formed in another conductor layer. However, this method requires punching and plating to be performed on all the double-sided printed circuit boards before stacking, which increases the number of steps and raises costs. Furthermore, when this method is employed, it is impossible to alternately stack the conductor layers 51/53 for the primary winding and the conductor layers 52/54 for the secondary winding, which will result in an increase in the high-frequency resistance of the planar transformer and an increase in its loss.

In contrast, in the present embodiment, all the through-holes 81, 82 and 83 for connecting the patterned conductors to each other entirely penetrate the planar transformer excluding the cores 41A and 42B in a direction of its thickness. Thus, according to the embodiment, the formation of the through-holes 81, 82 and 83, i.e., the punching and plating, can be performed at the same time as the formation of the through-holes 75 to 80 for terminals, after stacking all the conductor layers 51 to 54 and the insulating layers 50. This simplifies the manufacturing steps and reduces costs.

The remainder of the configuration, functions and effects of the present embodiment are the same as those of the first embodiment.

The present invention is not limited to the foregoing embodiments but may be modified in various ways. For example, the number of turns of the winding or the patterned conductors, and the number of conductor layers are not limited to those shown in the embodiments but may be set arbitrarily.

The present invention is also applicable to a planar transformer in which either the primary winding or the secondary winding is formed of a conductor other than plate-shaped ones, specifically, for example, a rounded wire conductor.

As described in the foregoing, in the first planar coil according to the invention, the third patterned conductor of the second winding is located on the same plane as at least one of the first and second patterned conductors of the first winding. This allows a high occupancy ratio of the area for accommodating the conductor of the first winding to the area for the entire conductors, and as a result, it is possible to reduce loss of the first winding. Furthermore, according to the invention, the third patterned conductor includes a portion that is wound one or more turns on an inner side relative to the connecting part that connects the inner ends of the first and second patterned conductors to each other. This makes it possible to attain a higher degree of flexibility in the number of turns of the second winding.

In the second planar coil according to the invention, the patterned conductor for the auxiliary winding is located on the same plane as at least one of the first and second patterned conductors. This allows a high occupancy ratio of the area for accommodating the conductor of the main winding to the area for the entire conductors, and as a result, it is possible to reduce loss of the main winding. Furthermore, according to the invention, the patterned conductor for the auxiliary winding includes a portion that is wound one or more turns on the inner side relative to the connecting part that connects the inner ends of the first and second patterned conductors to each other. This makes it possible to attain a higher degree of flexibility in the number of turns of the auxiliary winding.

In the planar transformer according to the invention, the patterned conductor for the auxiliary winding is located on the same plane as at least one of the first and second patterned conductors. This allows a high occupancy ratio of the area for accommodating the conductors of the primary and secondary windings to the area for the entire conductors, and as a result, it is possible to reduce losses of the primary and secondary windings. Furthermore, according to the invention, the patterned conductor for the auxiliary winding includes a portion that is wound one or more turns on the inner side relative to the connecting part that connects the inner ends of the first and second patterned conductors to each other. This makes it possible to attain a higher degree of flexibility in the number of turns of the auxiliary winding.

In the planar transformer according to the invention, one of the primary and secondary windings may have the first patterned conductor and the second patterned conductor; and the other of the primary and secondary windings may have a patterned conductor including a portion that is wound one or more turns on an inner side relative to a connecting part that connects the inner ends of the first and second patterned conductors to each other, the patterned conductor being located on a different plane from the first and second patterned conductors. In this case, it is possible to make an effective use of the area for accommodating the entire conductors.

In the planar transformer according to the invention, the inner ends of the first and second patterned conductors may be connected to each other via a connecting hole that entirely penetrates the planar transformer in a direction of its thickness. In this case, it is possible to simplify the manufacturing steps of the planer transformer.

In the planar transformer according to the invention, conductor layers including the patterned conductors to constitute the primary winding and conductor layers including the patterned conductors to constitute the secondary winding may be alternately stacked via an insulating layer. In this case, it is possible to reduce the high-frequency resistance of the planar transformer and increase the coupling coefficient between the primary and secondary windings.

It is apparent from the foregoing description that the invention may be carried out in various modes and may be modified in various ways. It is therefore to be understood that within the scope of equivalence of the appended claims the invention may be practiced in modes other than the foregoing best modes.

1. A planar coil comprising a first winding and a second winding each formed of a conductor, wherein:
the first winding has a first patterned conductor and a second patterned conductor each formed by arranging a conductor into a flat-spiral shape, the first and second patterned conductors being adjacent to each other via an insulating layer and having inner ends connected to each other; and
the second winding has a third patterned conductor including a portion that is wound one or more turns on an inner side relative to a connecting part that connects the inner ends of the first and second patterned conductors to each other, the third patterned conductor being located on the same plane as at least one of the first and second patterned conductors.

2. A planar coil comprising a main winding for performing a predetermined function and an auxiliary winding for performing another function, each of the windings being formed of a conductor, wherein:
the main winding has a first patterned conductor and a second patterned conductor each formed by arranging a conductor into a flat-spiral shape, the first and second patterned conductors being adjacent to each other via an insulating layer and having inner ends connected to each other; and
the auxiliary winding has a patterned conductor for the auxiliary winding, the patterned conductor for the auxiliary winding including a portion that is wound one or more turns on an inner side relative to a connecting part that connects the inner ends of the first and second patterned conductors to each other, the patterned conductor for the auxiliary winding being located on the same plane as at least one of the first and second patterned conductors.

3. A planar transformer comprising a primary winding and a secondary winding each formed of a conductor arranged into a flat shape, and an auxiliary winding provided separately from the primary winding and the secondary winding, wherein:
at least one of the primary and secondary windings has a first patterned conductor and a second patterned conductor each formed by arranging a conductor into a flat-spiral shape, the first and second patterned conductors being adjacent to each other via an insulating layer and having inner ends connected to each other; and
the auxiliary winding has a patterned conductor for the auxiliary winding that is formed by arranging a conductor into a flat-spiral shape, the patterned conductor for the auxiliary winding including a portion that is wound one or more turns on an inner side relative to a connecting part that connects the inner ends of the first and second patterned conductors to each other, the patterned conductor for the auxiliary winding being located on the same plane as at least one of the first and second patterned conductors.

4. A planar transformer according to claim 3, wherein:
one of the primary and secondary windings has the first patterned conductor and the second patterned conductor; and
the other of the primary and secondary windings has a patterned conductor including a portion that is wound one or more turns on an inner side relative to a connecting part that connects the inner ends of the first and second patterned conductors to each other, the patterned conductor being located on a different plane from the first and second patterned conductors.

5. A planar transformer according to claim 3, wherein the inner ends of the first and second patterned conductors are connected to each other via a connecting hole that entirely penetrates the planar transformer in a direction of its thickness.

6. A planar transformer according to claim 3, wherein conductor layers including the patterned conductors to constitute the primary winding and conductor layers including the patterned conductors to constitute the secondary winding are alternately stacked via an insulating layer.
